(19) United States
(12) Patent Application Publication
(10) Pub. No.: US 2026/0286750 A1
(43) Pub. Date: Sep. 24, 2026

(54) VEHICLE DOOR CONTROL DEVICE

(71) Applicant: AISIN CORPORATION, Kariya (JP)

(72) Inventors: Wei CHUCHU, Nantong (CN); Shinoda Yasutaka, Kariya (JP); Takayanagi Shinsuke, Nantong (CN)

(73) Assignee: AISIN CORPORATION, Kariya (JP)

(21) Appl. No.: 19/439,252

(22) Filed: Jan. 2, 2026

(30) Foreign Application Priority Data
Mar. 24, 2025 (CN) 202520523207.0

(51) Int. Cl. E05B 81/90; E05B 79/20; E05B 81/04; E05B 81/14

(52) U.S. Cl. CPC E05B 81/90; E05B 79/20; E05B 81/04; E05B 81/14

(57) ABSTRACT

A vehicle door control device to reduce the number of rocker arms while ensuring functionality. The device includes: first, second and third rocker arms and first and second control levers. The first rocker arm has a first and second elongated hole portions. A first idle pin passes through the first elongated hole portion and first sliding slot of the first control lever. A second idle pin sequentially passes through the second elongated hole portion and a second sliding slot of the second control lever. The second rocker arm is respectively connects an exterior handle and a locking mechanism of a vehicle via a cable, and the third rocker arm connects to an emergency release device. The first idle pin moves between first unlocking and locking positions in the first elongated hole portion, and the second idle pin moves between second unlocking and locking positions in the second elongated hole portion.

### FIELD OF THE DISCLOSURE

The present invention relates to a vehicle door control device.

### BACKGROUND

Known control devices for controlling the opening and closing of vehicle doors are disclosed in Patent Documents 1 and 2. Multiple rocker arms are provided in these control devices, each rocker arm is respectively connected to one of the vehicle door's interior handle, exterior handle, electronic signal unlocking mechanism, latching device, and an emergency unlock handle for manual unlocking in the event of a malfunction of the electronic signal unlocking mechanism. Locking and unlocking of the vehicle door are achieved by controlling the contact and separation of the rocker arms.

### CITATION LIST

### Patent Literature

### [Patent Literature 1]

Japanese Patent Application Publication No. 2008-144402.

### [Patent Literature 2]

Japanese Patent Application Publication No. 2012-72645.

In recent years, with the advancement of electronic control in vehicles, there has been a demand to eliminate interior handles. Furthermore, conventional control devices have a large number of rocker arms and a complex structure, and thus are no longer suitable for current vehicles.

In addition, because the emergency unlock handle is often mounted directly on the control device, the installation position of the control device is limited, and the design freedom of the vehicle door is further affected. Moreover, in order to avoid misoperation, a cover is usually provided on the inside of the vehicle door to shield the emergency unlocking handle, and consequently the aesthetics of the vehicle interior are affected.

### SUMMARY

An objective of the present invention is to provide a vehicle door control device that can reduce the number of rocker arms while ensuring functionality.

In one embodiment of the invention, the vehicle door control device includes: a first rocker arm, wherein the first rocker arm has a first elongated hole portion and a second elongated hole portion; a second rocker arm, wherein the second rocker arm is respectively connected to an exterior handle and a locking mechanism of a vehicle via a cable, and has a first abutting portion, so that the exterior handle or the locking mechanism can pull the second rocker arm via the cable to rotate; a third rocker arm, wherein the third rocker arm is connected to an emergency release device and has a second abutting portion, so that the emergency release device can pull the third rocker arm to rotate; a first control lever, wherein a first sliding slot is provided at one end of the first control lever, and a first idle pin sequentially passes through the first elongated hole portion and the first sliding slot; and a second control lever, wherein a second sliding slot is provided at one end of the second control lever, and a second idle pin sequentially passes through the second elongated hole portion and the second sliding slot; wherein the first idle pin is movable between a first unlocking position and a first locking position in the first elongated hole portion; at the first unlocking position, the first abutting portion abuts against the first idle pin, so that the first rocker arm can rotate in response to a rotation of the second rocker arm; at the first locking position, the first idle pin does not abut against the first abutting portion, so that the first rocker arm cannot rotate in response to the rotation of the second rocker arm; and the second idle pin is movable between a second unlocking position and a second locking position in the second elongated hole portion; at the second unlocking position, the second abutting portion abuts against the second idle pin, so that the first rocker arm can rotate in response to a rotation of the third rocker arm; at the second locking position, the second idle pin does not abut against the second abutting portion, so that the first rocker arm cannot rotate in response to the rotation of the third rocker arm.

According to this structure, by connecting both the first control lever and the second control lever to the first rocker arm, and connecting both an exterior handle cable and a release cable to the second rocker arm, so that the number of rocker arms can be reduced. The device structure is simplified and manufacturing costs are reduced, while the functionality of the vehicle door control device is maintained.

Furthermore, in the embodiment, preferably, a first electric arm driven by a motor is further included. The first electric arm is rotatably connected to the other end of the first control lever, so that the first electric arm can drive the first control lever to rotate.

According to this structure, the first control lever can be reliably controlled in an electrically controlled manner.

Furthermore, in the embodiment, preferably, a second electric arm driven by a motor is further included. The second electric arm is rotatably connected to the other end of the second control lever, so that the second electric arm can drive the second control lever to rotate.

According to this structure, because the second control lever is driven by the second electric arm, the emergency release device can be locked with a simple operation or automatically by an ECU of the vehicle. Therefore, compared with a case in which the emergency release device is shielded with a cover or the like to prevent misoperation, there is no need to hide the emergency release device, thereby facilitating use by the occupant.

Furthermore, in the event of a vehicle collision, a signal can be sent to the motor of the second electric arm, so that the second electric arm can automatically move the second idle pin to the second unlocking position. This ensures safety in the event of a vehicle collision.

Furthermore, because the second rocker arm and the third rocker arm rotate independently of each other, and the first control lever and the second control lever are controlled by the first electric arm and the second electric arm, respectively. Therefore, by designing the timing of sending control signals in the vehicle to the first electric arm and the second electric arm, different locking/unlocking logics can be implemented, and the needs of different vehicle manufacturers can be met.

Furthermore, in the embodiment, preferably, the third rocker arm is connected to the emergency release device via a cable.

According to this structure, compared with a case in which the emergency release device is directly provided on the vehicle door control device, the emergency release device can be provided at a position that is more easily accessible by the occupant, so that user experience and the design freedom can be further improved.

Furthermore, in the embodiment, preferably, the emergency release device is in the shape of a handle exposed on a vehicle interior side of the vehicle door.

According to this structure, when there is no emergency in the vehicle, the emergency release device can also be used as an interior handle. Therefore, the interior handle of the vehicle can be eliminated, so that the rocker arm connected to the interior handle can be eliminated, and manufacturing costs can be further reduced. Furthermore, by eliminating the interior handle, the vehicle door control device can be completely housed within the door interior, without being exposed to the vehicle interior. The door interior can be made more uniform, and the aesthetics of the interior and the design freedom are improved.

Furthermore, in the embodiment, preferably, a control handle is further included. The control handle is exposed on a vehicle interior side of the vehicle door and is rotatably connected to the other end of the second control lever via a cable or a linkage, so that when the control handle is manually operated, the second control lever can be driven to rotate.

According to this structure, the function of a child protection mechanism can be implemented by using a manually controlled control handle.

Furthermore, in the embodiment, preferably, a base plate and a return spring are further included. The first rocker arm, the second rocker arm, and third rocker arm are rotatably mounted to the base plate via a shaft, one end of the return spring is connected to the second rocker arm, and the other end of the return spring is connected to the base plate, and when an operation of the exterior handle or the locking mechanism on the second rocker arm is completed, the return spring returns the second rocker arm to its original position.

According to this structure, the usability of the vehicle door control device can be improved with a simple structure.

### BRIEF DESCRIPTION OF THE DRAWINGS

FIG. 1 is a schematic diagram of an overall structure of a vehicle door control device, showing the vehicle door control device in an unlocked state.

FIG. 2 is an exploded perspective view of a vehicle door control device.

FIG. 3 is a diagram illustrating a locking function of the vehicle door control device.

FIG. 4 is a diagram illustrating a state of a vehicle door control device when a vehicle door is opened or closed.

FIG. 5 is a diagram illustrating an emergency unlocking function of a vehicle door control device.

FIG. 6 is a diagram illustrating a child protection function of a vehicle door control device.

FIG. 7 is a diagram illustrating an unlocking function of a vehicle door control device.

### DETAILED DESCRIPTION

Hereinafter, a preferred embodiment of a vehicle door control device will be described with reference to the accompanying drawings. In this embodiment, the vehicle door is a sliding door of a vehicle, and the opening is a vehicle door opening. Furthermore, when terms such as “up,” “down,” “left,” and “right” are used in the embodiments to indicate directions, these terms refer to the directions in the drawings and are not intended to limit the directions of the vehicle door control device in actual use. “A”, “an”, and “the” as used herein refers to both singular and plural referents unless the context clearly dictates otherwise.

### Structure of the Control Device

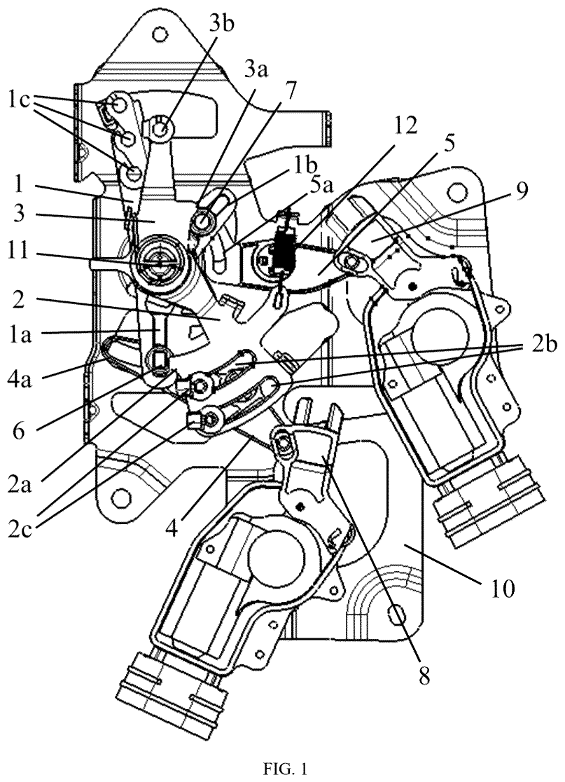

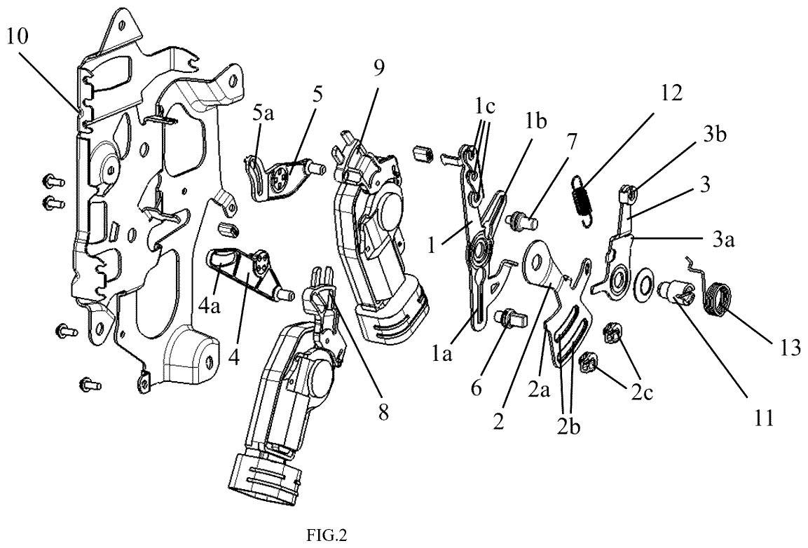

First, with reference to FIGS. 1 and 2, a specific structure of the vehicle door control device is described. FIG. 1 is a diagram of a vehicle door control device in an unlocked state.

As shown in FIGS. 1 and 2, the vehicle door control device includes a base plate 10, a first rocker arm 1, a second rocker arm 2, a third rocker arm 3, a first control lever 4, a second control lever 5, a first electric arm 8, and a second electric arm 9. The first rocker arm 1, the second rocker arm 2, and the third rocker arm 3 are rotatably mounted to the base plate 10 via a shaft 11.

The first rocker arm 1 is in the shape of a long strip, and has a first elongated hole portion 1a and a second elongated hole portion 1b. The first elongated hole portion 1a is located at one end of the first rocker arm 1 in a length direction and extends along the length direction of the first rocker arm 1. The second elongated hole portion 1b extends from a portion near the middle of the first rocker arm 1 along the length direction toward a direction intersecting the length direction (in this embodiment, obliquely upward). Three cable connection holes 1c are provided at the other end of the first rocker arm 1 along the length direction, and are used to perform operations on, for example, a front lock, an electric rear lock, and a full-open limit lock of the sliding door (not shown) via the cables.

The first control lever 4 is mounted on the base plate 10. A first sliding slot 4a is provided at one end of the first control lever 4. A first idle pin 6 sequentially passes through the first elongated hole portion 1a and the first sliding slot 4a of the first rocker arm 1, so that the first elongated hole portion 1a can be rotatably connected to the first control lever 4 via the first idle pin 6. A first electric arm 8 is driven by a motor and is rotatably connected to the other end of the first control lever 4, so that the first electric arm 8 can drive the first control lever 4 to rotate.

The second control lever 5 is mounted on the base plate 10. A second sliding slot 5a is provided at one end of the second control lever 5. A second idle pin 7 sequentially passes through the second elongated hole portion 1b and the second sliding slot 5a of the of the first rocker arm 1, so that the second elongated hole portion 1b can be rotatably connected to the second control lever 5 via the second idle pin 7. A second electric arm 9 is driven by a motor and is rotatably connected to the other end of the second control lever 5, so that the second electric arm 9 can drive the second control lever 5 to rotate. The second control lever 5 and the second electric arm 9 constitute a child protection mechanism of this embodiment.

The second rocker arm 2 is respectively connected to an exterior handle and an electric lock (a locking mechanism) (not shown) of the vehicle via the cables. The exterior handle or the electric lock can pull the second rocker arm 2 to rotate via the cable. Specifically, the second rocker arm 2 has two sliding slots 2b, and two cable connectors 2c are inserted into the two sliding slots respectively. The two cable connectors 2c are connected to the exterior handle and the electric lock via an exterior handle cable and a release cable, respectively.

The vehicle door control device further comprises a return spring 12 and a torsion spring 13. One end of the return spring 12 is connected to the second rocker arm 2, and the other end is connected to the base plate 10. The torsion spring 13 is mounted on the shaft 11, and abuts against the first rocker arm 1 via a protruding part that protrudes radially outward from the shaft 11.

The third rocker arm 3 has a cable mounting portion 3b for mounting a cable. The third rocker arm 3 is connected to an emergency release device (not shown) via a cable (not shown). This emergency release device can pull the third rocker arm 3 to rotate. In this embodiment, the emergency release device is in the shape of a handle exposed on a vehicle interior side of the vehicle door. In emergency situations such as a vehicle collision or power failure, the sliding door can be opened by the occupant's control of the emergency release device. The detailed operation of the emergency release device is described later.

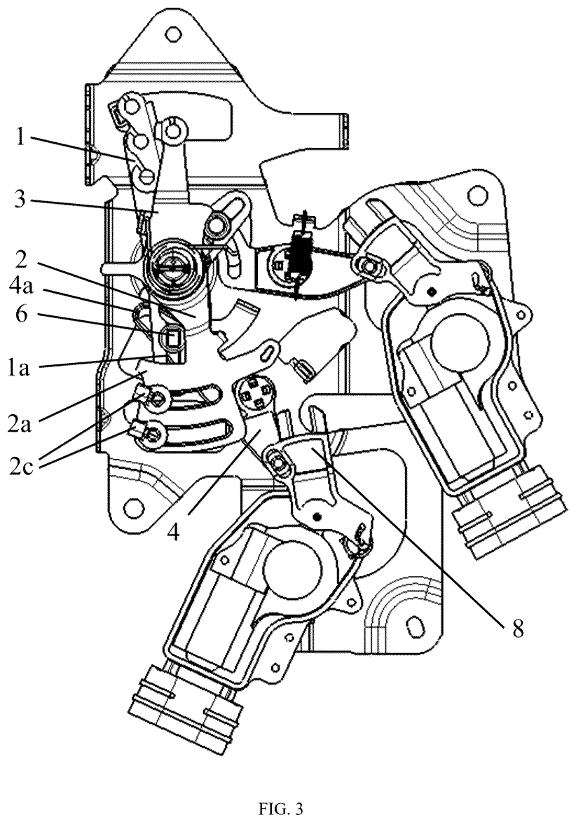

The second rocker arm 2 is provided with a first abutting portion 2a. When rotating, the first control lever 4 causes the first idle pin 6 to move between a first unlocking position (see FIG. 1) and a first locking position (see FIG. 3) in the first elongated hole portion 1a. At the first unlocking position, the first abutting portion 2a abuts against the first idle pin 6, so that the first rocker arm 1 can rotate with the rotation of the second rocker arm 2. At the first locking position, the first idle pin 6 does not abut against the first abutting portion 2a, so that the first rocker arm 1 cannot rotate with the rotation of the second rocker arm 2.

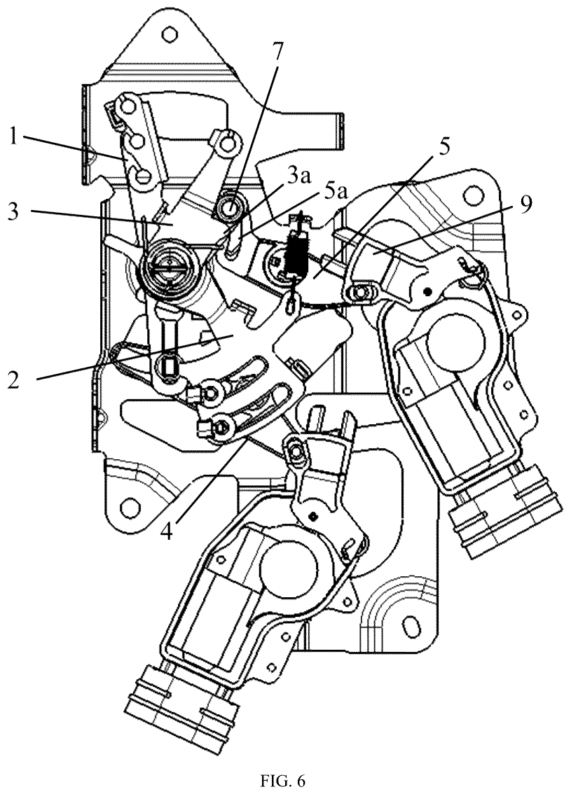

The third rocker arm 3 is provided with a protrusion 3a. When rotating, the second control lever 5 causes the second idle pin 7 to move between a second unlocking position (see FIG. 1) and a second locking position (see FIG. 6) in the second elongated hole portion 1b. At the second unlocking position, the lower surface (a second abutting portion) of the protrusion 3a abuts against the second idle pin 7, so that the first rocker arm 1 can rotate with the rotation of the third rocker arm 3. At the second locking position, the second idle pin 7 does not abut against the lower surface of the protrusion 3a, so that the first rocker arm 1 cannot rotate with the rotation of the third rocker arm 3.

### Locking Function

With reference to FIG. 1 and FIG. 3, the locking function of the vehicle door control device is described below.

While the vehicle is moving, or when the vehicle is stopped and the key is not detected, it is necessary to ensure that the front lock and the electric rear lock of the sliding door are in a locked state.

In this case, a control signal is sent to a motor of the first electric arm 8 via an ECU of the vehicle, so that the motor controls the first electric arm 8 to rotate counterclockwise from the state shown in FIG. 1. Thus, the first electric arm 8 drives the first control lever 4 to rotate clockwise, so that the first control lever 4 causes the first idle pin 6 to move upward within the first elongated hole portion 1a via the first sliding slot 4a. In this way, the first idle pin 6 moves from the first unlocking position shown in FIG. 1 to the first locking position shown in FIG. 3, so that the first idle pin 6 does not abut against the first abutting portion 2a of the second rocker arm 2. Therefore, even if the exterior handle pulls the second rocker arm 2 via the exterior handle cable, or a signal is sent to the electric lock by using the unlock button, causing the electric lock to pull the second rocker arm 2 via the release cable, the second rocker arm 2 cannot drive the first rocker arm 1 to rotate, and thus the first rocker arm 1 cannot be used to control the front lock or the electric rear lock of the sliding door to perform unlocking.

### Unlocking Function, Opening and Closing Function of the Sliding Door

With reference to FIGS. 1, 3, and 4, the unlocking function of the vehicle door control device is described below.

For example, when the sliding door needs to be opened or closed while the vehicle is stopped, a control signal is sent to a motor of the first electric arm 8 via an ECU of the vehicle, so that the motor controls the first electric arm 8 to rotate clockwise from the position shown in FIG. 3. Thus, the first electric arm 8 drives the first control lever 4 to rotate counterclockwise, so that the first control lever 4 causes the first idle pin 6 to move downward within the first elongated hole portion 1a via the first sliding slot 4a. In this way, the first idle pin 6 moves from the first locking position shown in FIG. 3 to the first unlocking position shown in FIG. 1, so that the first idle pin 6 abuts against the first abutting portion 2a of the second rocker arm 2.

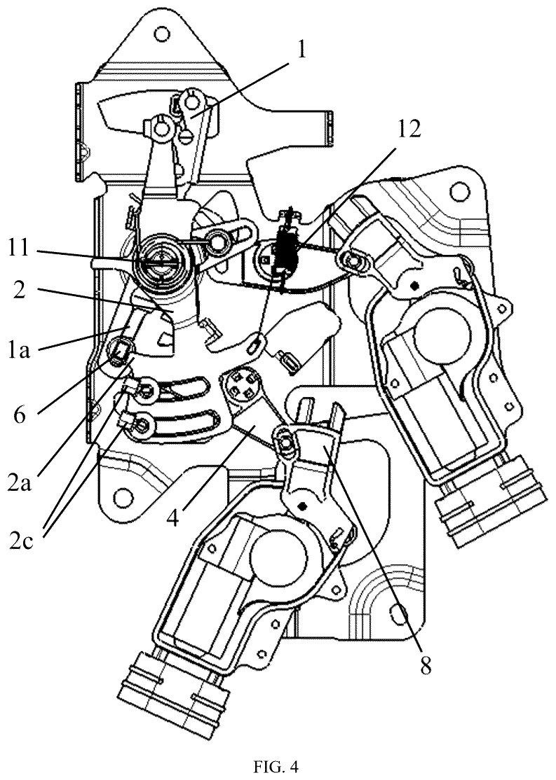

Next, as shown in FIG. 4, the exterior handle or the electric lock pulls the cable connector 2c via the exterior handle cable or the release cable, causing the second rocker arm 2 to rotate leftward via the cable connector 2c. In this way, the second rocker arm 2, via the first abutting portion 2a, pushes the first idle pin 6 in the first elongated hole portion 1a of the first rocker arm 1, thereby pushing the first rocker arm 1 to rotate about the shaft 11 via the first idle pin 6. Thus, the first rocker arm 1 operates the front lock and the electric rear lock of the sliding door via the cable, causing the sliding door to open and close. In this case, the return spring 12 is stretched as the second rocker arm 2 rotates, and the torsion spring 13 is pushed and tightened by the first rocker arm 1.

Next, the exterior handle or the electric lock stops pulling the cable connector 2c, and the second rocker arm 2 returns to the position shown in FIG. 1 by using the restoring force of the return spring. Because the second rocker arm 2 no longer pushes the first rocker arm 1, the first rocker arm 1 also returns to the position shown in FIG. 1 by using the restoring force of the torsion spring 13.

### Operation of the Emergency Release Device

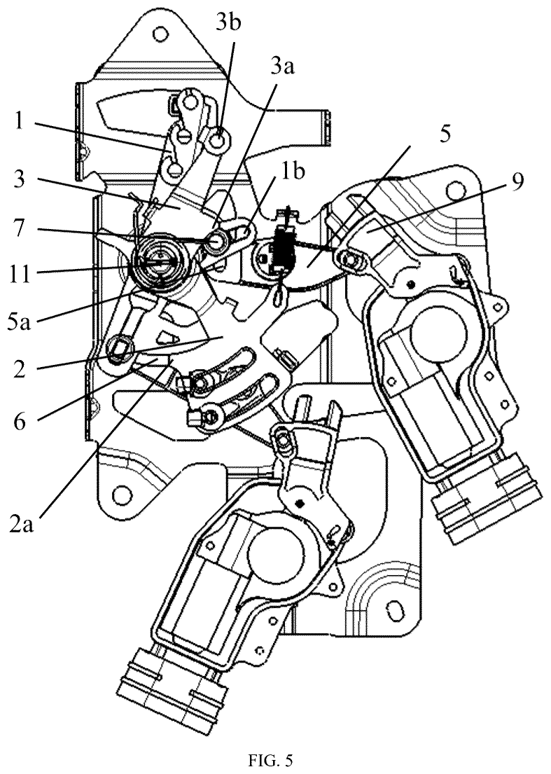

With reference to FIGS. 1 and 5, the operation of the emergency release device is described.

In emergency situations such as a vehicle collision or power failure, there's a possibility that a signal cannot be sent to a motor of the first electric arm 8, and therefore there is a need to perform manual unlocking within the vehicle cabin.

When the second control lever 5 is in the state shown in FIG. 1 and an occupant operates the emergency release device, the emergency release device pulls a cable mounting portion 3b of the third rocker arm 3 via a cable (not shown), causing the third rocker arm 3 to rotate clockwise. As shown in FIG. 5, the third rocker arm 3 pushes the second idle pin 7 via the lower surface of the protrusion 3a, thereby pushing the first rocker arm 1 to rotate around the shaft 11 via the second idle pin 7. Thus, the first rocker arm 1 operates the front lock and the electric rear lock of the sliding door via the cable to perform unlocking, so that the sliding door can be opened. In this case, the torsion spring 13 is pushed and tightened by the first rocker arm 1.

Next, the occupant stops operating the emergency release device, and the first rocker arm 1 returns to the position shown in FIG. 1 by using the restoring force of the torsion spring 13, and the first rocker arm 1 drives the third rocker arm 3 to return to the position shown in FIG. 1 by using the second idle pin 7.

In this way, even if the first electric arm 8 is inoperative, the third rocker arm 3 can rotate the first rocker arm 1 independently of the second rocker arm 2, thereby controlling the front lock and the electric rear lock of the sliding door and achieving the emergency unlocking function.

### Operation of a Child Protection Mechanism

With reference to FIGS. 1, 6, and 7, the child protection mechanism of this embodiment is described.

In the unlocked state shown in FIG. 1, when an ECU of the vehicle receives a child-protection activation command from an occupant, a control signal is sent to a motor of the second electric arm 9, so that the motor controls the second electric arm 9 to rotate counterclockwise from the state shown in FIG. 1. Thus, the second electric arm 9 drives the second control lever 5 to rotate clockwise, so that the second control lever 5 causes the second idle pin 7 to move upward within the second elongated hole portion 1b via the second sliding slot 5a. In this way, the second idle pin 7 moves from the second unlocking position shown in FIG. 1 to the second locking position shown in FIG. 6, so that the second idle pin 7 does not abut against the lower surface of the protrusion 3a. Therefore, even if an occupant operates the emergency release device and pulls the third rocker arm 3 via the cable, the third rocker arm 3 cannot drive the first rocker arm 1 to rotate via the second idle pin 7, and cannot control the front lock and the electric rear lock of the sliding door by using the first rocker arm 1 to perform unlocking. Thus, this can prevent the sliding door from being unlocked due to the occupant mistakenly operating the emergency release device while the vehicle is moving.

Furthermore, in the state shown in FIG. 6, when an ECU of the vehicle receives a child-protection release command from an occupant, a control signal is sent to a motor of the second electric arm 9, so that the motor controls the second electric arm 9 to rotate clockwise from the state shown in FIG. 6. Thus, the second electric arm 9 drives the second control lever 5 to rotate counterclockwise, and the second control lever 5 causes the second idle pin 7 to move, via the second sliding slot 5a, from the second locking position (FIG. 6) to the second unlocking position (FIG. 1), so that the second idle pin 7 abuts against the lower surface of the protrusion 3a. Thus, the occupant can control the front lock and the electric rear lock of the sliding door by operating the emergency release device as described above.

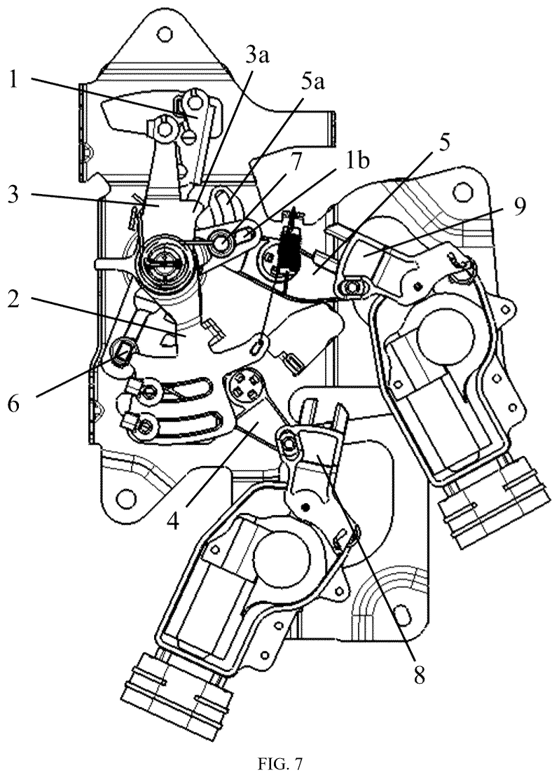

Furthermore, as shown in FIG. 7, because the rotation of the second rocker arm 2 is independent of the rotation of the third rocker arm 3, even when the child-protection mechanism is activated as shown in FIG. 6, the second rocker arm 2 can drive the first rocker arm 1 to rotate by operating the exterior handle or the unlock button. In this case, because the upper surface of the protrusion 3a of the third rocker arm 3 is formed into a smooth arc that bulges radially outward, when the emergency release device is released and the third rocker arm 3 is reset by the torsion spring (not shown), the second idle pin 7 can disengage from the upper surface of the protrusion 3a as the first rocker arm 1 rotates and slide freely within the second sliding slot 5a and the second elongated hole portion 1b. Therefore, the third rocker arm 3, the second control lever 5, and the second electric arm 9 do not affect the rotation of the first rocker arm 1. That is, activation of the child-protection mechanism does not affect the operation of the exterior handle or the unlock button.

### Effects of the Embodiment

The effects of this embodiment are described below.

In this embodiment, both the first control lever 4 and the second control lever 5 are connected to the first rocker arm 1, and both the exterior handle cable and the release cable are connected to the second rocker arm 2, so that the number of rocker arms is reduced. The device structure is simplified and manufacturing costs are reduced while the functionality of the vehicle door control device is maintained.

In this embodiment, the emergency release device is designed in the shape of a handle exposed on a vehicle interior side of the vehicle door. The emergency release device can also be used as an interior handle when the vehicle is not in an emergency. Therefore, an interior handle can be eliminated, the rocker arm connected to the interior handle can be eliminated. In this way, manufacturing costs can be further reduced.

Furthermore, because the child-protection mechanism driven by the second electric arm 9 is provided, the emergency release device can be locked by a simple operation or automatically by the ECU of the vehicle. Therefore, compared with a case in which the emergency release device is shielded with a cover or the like to prevent misoperation, there is no need to hide the emergency release device, thereby facilitating use by the occupant.

Furthermore, in the event of a vehicle collision, a signal can be sent from a backup power supply to the motor of the second electric arm 9, so that the second electric arm 9 can automatically move the second idle pin 7 to the second unlocking position. Thus, vehicle safety can be ensured in the event of a collision.

Furthermore, the second rocker arm 2 and the third rocker arm 3 rotate independently of each other, and the first control lever 4 and the second control lever 5 are controlled by the first electric arm 8 and the second electric arm 9, respectively. Therefore, by designing the timing of sending control signals in the vehicle to the first electric arm 8 and the second electric arm 9, different locking/unlocking logics can be implemented, and the needs of different vehicle manufacturers can be met. For example, it can be designed that when the occupant sends a locking command, the first electric arm 8 and the second electric arm 9 are simultaneously driven to move both the first idle pin 6 and the second idle pin 7 to the locking position. Alternatively, it can be designed that the occupant can drive the first electric arm 8 and the second electric arm 9 separately with different commands.

Furthermore, because the emergency release device is connected to the third rocker arm 3 via a cable, compared with a case in which the emergency release device is directly mounted on the vehicle door control device, the emergency release device can be placed in a position that is more easily accessible to the occupant, so that design freedom is improved.

Furthermore, in this embodiment, because the interior handle is eliminated, and the emergency release device can be positioned arbitrarily, the vehicle door control device can be completely housed within the door interior, preventing the vehicle door control device from being exposed to the vehicle interior. The door interior can be more uniform, and the aesthetics of the interior and the freedom of design are improved.

### Other Embodiments

Preferred embodiments of the present invention have been described above, but the present invention is not limited thereto, and various modifications are possible without departing from the scope of the present invention.

In the above embodiment, the child protection mechanism is described as including the second control lever 5 and the second electric arm 9, but the present invention is not limited thereto. For example, the second electric arm 9 may not be used, and a control handle manually operated by an occupant inside the vehicle can be provided in place of the second electric arm 9. This control handle is exposed on a vehicle interior side of the vehicle door and can be rotatably connected to the other end of the second control lever 5 via a cable or a linkage. In this way, when the control handle is manually operated, the second control lever 5 can be driven to rotate. The functions of the child protection mechanism described above can also be implemented by using this control handle.

In the above embodiment, the emergency release device is described in the shape of a handle exposed on a vehicle interior side of the vehicle door, but the present invention is not limited thereto. The specific shape of the emergency release device is not particularly limited, provided that it is a shape that facilitates operation by the user.

In addition, the ECU can be instructed to send a signal to the motor of the first electric arm 8 or the motor of the second electric arm 9 as described in the above embodiment by various well-known methods, such as a physical lock button and unlock button, an in-vehicle touch screen, an application program on a mobile terminal of an occupant, and a car key. Certainly, the ECU can also automatically send the above signal based on a current state of the vehicle. Alternatively, the occupant can directly send the signal to the motor of the first electric arm 8 and the motor of the second electric arm 9 without using the ECU of the vehicle.

The present invention has been described above with reference to a specific example. However, the present invention is not limited to this specific example. Designs obtained by the person skilled in the art by appropriately modifying this specific example, as long as they possess the features of the present invention, are also within the scope of the present invention.

### Reference Signs List

1 First rocker arm
2 Second rocker arm
3 Third rocker arm
4 First control lever
5 Second control lever
6 First idle pin
7 Second idle pin
8 First electric arm
9 Second electric arm
10 Base plate
11 Shaft
12 Return spring
13 Torsion spring

What is claimed is:

1. A vehicle door control device, comprising:
a first rocker arm, wherein the first rocker arm has a first elongated hole portion and a second elongated hole portion;
a second rocker arm, wherein the second rocker arm is respectively connected to an exterior handle and a locking mechanism of a vehicle via a cable, and has a first abutting portion, so that the exterior handle or the locking mechanism can pull the second rocker arm via the cable to rotate;
a third rocker arm, wherein the third rocker arm is connected to an emergency release device and has a second abutting portion, so that the emergency release device can pull the third rocker arm to rotate;
a first control lever, wherein a first sliding slot is provided at one end of the first control lever, and a first idle pin sequentially passes through the first elongated hole portion and the first sliding slot; and
a second control lever, wherein a second sliding slot is provided at one end of the second control lever, and a second idle pin sequentially passes through the second elongated hole portion and the second sliding slot;
wherein the first idle pin is movable between a first unlocking position and a first locking position in the first elongated hole portion; at the first unlocking position, the first abutting portion abuts against the first idle pin, so that the first rocker arm can rotate in response to a rotation of the second rocker arm; at the first locking position, the first idle pin does not abut against the first abutting portion, so that the first rocker arm cannot rotate in response to the rotation of the second rocker arm; and
the second idle pin is movable between a second unlocking position and a second locking position in the second elongated hole portion; at the second unlocking position, the second abutting portion abuts against the second idle pin, so that the first rocker arm can rotate in response to a rotation of the third rocker arm; at the second locking position, the second idle pin does not abut against the second abutting portion, so that the first rocker arm cannot rotate in response to the rotation of the third rocker arm.

2. The vehicle door control device according to claim 1, further comprising:
a first electric arm driven by a motor, wherein the first electric arm is rotatably connected to the other end of the first control lever, so that the first electric arm can drive the first control lever to rotate.

3. The vehicle door control device according to claim 1, further comprising:
a second electric arm driven by a motor, wherein the second electric arm is rotatably connected to the other end of the second control lever, so that the second electric arm can drive the second control lever to rotate.

4. The vehicle door control device according to claim 1, wherein the third rocker arm is connected to the emergency release device via a cable.

5. The vehicle door control device according to claim 4, wherein the emergency release device is in the shape of a handle exposed on a vehicle interior side of the vehicle door.

6. The vehicle door control device according to claim 1, further comprising:
a control handle, wherein the control handle is exposed on a vehicle interior side of the vehicle door and is rotatably connected to the other end of the second control lever via a cable or a linkage, so that when the control handle is manually operated, the second control lever can be driven to rotate.

7. The vehicle door control device according to any one of claim 1, further comprising:
a base plate and a return spring, wherein
the first rocker arm, the second rocker arm, and the third rocker arm are rotatably mounted on the base plate via a shaft,
one end of the return spring is connected to the second rocker arm, and the other end of the return spring is connected to the base plate, and
when an operation of the exterior handle or the locking mechanism on the second rocker arm is completed, and the return spring returns the second rocker arm to an original position.
